(19) United States
(12) Patent Application Publication
(10) Pub. No.: US 2018/0023009 A1
(43) Pub. Date: Jan. 25, 2018

(54) Method and Device for Enhanced Oil-Water Separation and Desalination in Cold Low-Pressure Separator

(71) Applicant: East China University of Science and Technology, Shanghai (CN)

(72) Inventors: Qiang YANG, Shanghai (CN); Hao LU, Shanghai (CN); Sen LIU, Shanghai (CN); Chaoyang WANG, Shanghai (CN); Xiao XU, Shanghai (CN)

(21) Appl. No.: 15/549,385

(22) PCT Filed: May 4, 2015
(86) PCT No.: PCT/CN2015/000302

§ 371 Date: Aug. 8, 2017

(30) Foreign Application Priority Data
Feb. 9, 2015 (CN) 201510066396.4

(51) Int. Cl. C10G 53/02; B01D 17/02; B01D 17/04; B01D 19/00

(52) U.S. Cl. CPC C10G 53/02; B01D 19/0036; B01D 17/0214; B01D 19/0052; B01D 17/045; B01D 17/0217; C10G 2300/205; C10G 2300/805

(57) ABSTRACT

This invention involves a method and a device for enhanced oil-water separation and desalination in a low-pressure separator. The water-containing oil is mixed with desalted water in a countercurrent way at the entrance, wherein the desalted water accounts for 0-1% of the water-containing oil by volume. The resultant oil-water mixture then enters a T-shaped liquid-gas separator (3) for degassing treatment to quickly separate gas from the mixture. In a low-pressure separator, the oil-water mixture flows, from left to right, to a flow conditioner (4) to uniformly distribute the mixture in the transverse section, and then flows to a hydrophilic droplet agglomeration module (5) and a CPI fast separation module (6) to separate water from oil, wherein part of the separated water is discharged and the oil with a trace of water (0-0.01%) passes over a partition (18) to a deep separation segment. The oil is subjected to deep water removal by a conjugated fiber water removal module and then discharged, and the water captured by the conjugated fiber water removal module is subject to a conjugated fiber oil removal module for deep oil removal and then discharged.

### FIELD OF INVENTION

This invention involves the field of petroleum refining or coal chemical industry. In particular, the instant invention relates to a method and a device for enhanced oil-water separation and desalination in a cold low-pressure separator.

### BACKGROUND OF THE INVENTION

In a hydrogenation unit, a low-pressure separator works on the basis of equilibrium vaporization in distillation. In other words, the pressure is reduced for the feedstock in a certain way, and gas and liquid in the feedstock are rapidly separated in the space of one vessel under a certain temperature and a certain pressure to obtain corresponding gas and liquid products. The low-pressure separator functions to separate the gas components from the liquid components contained in the feedstock supplied to a cold high-pressure separator so that part of the gas components are evaporated to reduce the gas load of the fractionation system. The low-pressure separator also functions, in view of the high content of hydrogen sulfide in the gas components, to remove part of the hydrogen sulfide from the low-pressure separator so as to reduce equipment corrosion in the fractionation system.

Currently, the gravity settler is conventionally adopted for separation in a low-pressure separator. During the separation, there are three problems as follows. (1) Liquid-gas separating effect is poor because the scattered tiny bubbles separated through flash evaporation under reduced pressure can't be effectively eliminated during the gravity settling and will be carried into acidic water or the fractionated oil, causing gas (mainly hydrogen) loss and increased downstream load. (2) Gravity settling is adopted for oil-water separation for 10 minutes or longer but the separating effect is poor with large area occupied by the settling unit. (3) The quality of oil product is worsened and thus more salt and hydrogen sulfide are contained in the fractionated oil, which results in a bad water-removing effect on the fractionated oil and also serious corrosion in downstream steam stripping and distillation units. Desalination function has not been taken into consideration in current design of the low-pressure separator. Therefore, it is necessary to adopt new efficient technology to optimize the current low-pressure separator.

### SUMMARY OF THE INVENTION

In consideration of the foregoing problems, this invention provides a method and a device for enhanced oil-water separation with desalination in a cold low-pressure separator. With the method and the device, enhanced oil-water separation is carried out, taking advantage of material characteristics and flow field regulation. Meanwhile, water is injected to wash and remove hydrogen sulfide and salts contained in oil, to further enhance oil-water separation and effectively remove the salts in an efficient way, which will compensate for the deficiencies of the conventional cold low-pressure separator.

The instant invention provides a method for enhanced oil-water separation and desalination in a cold low-pressure separator, comprising the steps of

1) mixing water-containing oil with desalted water at entrance to transfer salts and hydrogen sulfide in the oil to the desalted water, and flowing the resultant oil-water mixture into a T-shaped liquid-gas separator to rapidly separate gas from the oil-water mixture via flash evaporation, wherein the oil has a pressure of 0.6-4.5 MPa and a temperature of 20-90° C. at the entrance, and the desalted water is injected in such a rate that the injected desalted water accounts for 0-1% of the water-containing oil by volume;

2) subjecting the oil-water mixture to secondary washing by injected water, flow conditioning and preliminary separation to separate water having a droplet size over 30 μm, wherein a hydrophilic droplet agglomeration module and a CPI fast separation module are used in the preliminary separation, the hydrophilic droplet agglomeration module is adopted to rapidly agglomerate the water droplets scattering in oil, and the CPI fast separation module performs rapid oil-water separation, the separated water is automatically discharged from bottom by an oil-water interface level controller, or alternatively enters a deep separation chamber through ports at both sides of a partition while oil with a trace of water flows through the partition for next processing step, wherein the water injected in the secondary washing accounts for 0-0.5% of the oil-water mixture, the conditioned oil-water mixture flows in a flow velocity of 0.005-0.05 m/s, and space between each two adjacent corrugated plates in the CPI module is 5-18 mm; and

3) subjecting the oil with a trace of water to gravity settling followed by a conjugated fiber water removal module containing hydrophilic fibers and oleophilic fibers to separate water droplets having a size of 3-301 μm, automatically discharging the resultant oil by a liquid level controller while subjecting the separated water to a conjugated fiber oil removal module containing hydrophilic fibers and oleophilic fibers to obtain water containing less than 100 mg/L of oil and then automatically discharging the resultant water by an oil-water interface level controller, wherein water droplets with larger size are settled down during the gravity settling to bottom and then into a water bag;

wherein the amount of the hydrophilic fibers is 5 to 15% of that of the oleophilic fibers in the conjugated fiber water removal module; the amount of the oleophilic fibers is 10 to 20% of that of the hydrophilic fibers in the conjugated fiber oil removal module.

The desalted water is injected in step 1) in a direction that is the same with or opposite to the oil's flowing direction. The injected water is dispersed in the oil with a droplet size of 10 to 50 μm. The amount of the injected desalted water can be adjusted depending on the salt content in the oil.

The flow rate of the oil-water mixture at entrance of the T-shaped liquid-gas separator in step 1) is from 3 to 6 m/s.

In the secondary washing in step 2), the water is injected in a direction opposite to the oil's flowing direction by a jet and a pipe. The injected water is dispersed in oil in a droplet size of 30 to 100 μm.

The hydrophilic droplet agglomeration module and the CPI fast separation module mentioned in step 2) are made of modified Teflon, polypropylene or stainless steel material.

The conjugated fiber water/oil removal module mentioned in step 3) adopts weaving type described in Chinese patent publication 103952853A.

The instant invention also provides a device for enhanced oil-water separation and desalination for carrying out the method of the instant invention, comprising a casing, an oil-water-gas inlet disposed on the casing, an injector and a T-shaped liquid-gas separator (or a rotational flow degasser) separately connected with the oil-water-gas inlet; a second injector, a flow conditioner, an oil-water agglomeration module, a CPI fast separation module, an oil-water interface level controller, a partition, a liquid level controller, and an oil outlet, which are disposed within the casing in said order, with the oil outlet disposed at posterior end of the casing; a liquid eliminator disposed on bottom of the casing, a gas outlet on top of the casing, and a water outlet on the bottom of the casing.

The oil outlet, the gas outlet and the water outlet are provided with a regulating valve, respectively.

An oil-water interface level controller is disposed inside the liquid eliminator.

The above mentioned casing is a horizontal type or a vertical type casing.

The beneficial effects of this invention are as follows.

(1) The technology using the T-shaped liquid-gas separator is adopted in this invention. The gas is quickly removed from the liquid via flash evaporation by the centrifugal force of the liquid in the tube of the T-shaped separator. In this respect, a higher separation efficiency than gravity settling separation is realized using a simple configuration. In another aspect, water is injected prior to the entry to the T-shaped separator. When the flow rate of the oil at the entrance of T-shaped tube is controlled at 3 to 6 m/s, uniformly dispersed water droplets get influenced by centrifugal force in the tube of the T-shaped separator. Due to different densities of oil and water, water drops moves from center to periphery on the transverse section and from top to bottom on the longitudinal section to further remove salts. The water droplets with a size of 10 to 50 μm are not likely to break or get emulsified under the centrifugal force, making it optimized for subsequent efficient separation.
(2) A second water injection is adopted. On one hand, water volume to be injected is reduced and deep desalting is realized. On the other hand, fast separation of oil from water can be improved. Flow bias exists if water is only injected once, and the residence time is short in the separation process using the T-shaped tube. Thus, a part of oil is not sufficiently washed by the water. The salts will be removed again by water injected for the second time. Moreover, the size of water droplets is controlled at 30 to 100 μm during the second water injection and these water droplets are in dispersed state. Such water droplets can quickly gather on the surface of baffle plates of the agglomeration module to form a water film. Small water droplets carried by oil such as the water droplets with a size less than 30 μm can attach to the water film to from big liquid droplets so as to improve the coalescence of the agglomerated water droplets.
(3) The rough water removal and the further water removal are performed in one casing. Water droplets whose particle sizes are larger than 30 μm are mainly removed before the oil-water mixture enters the partition. Conjugated fibers are used to realize deep water removal after the mixture passes the partition. The amount of the hydrophilic fibers is 5 to 15% of that of the oleophilic fibers in the conjugated fiber water removal module. In the meantime of maintaining low pressure settlement (it is easy for oil to penetrate the fibrous layer through oleophilic fibers), deep separation of water droplets are realized (a part of emulsified oil droplets carry tiny water droplets and this part of water droplets are stopped and separated by hydrophilic fibers). Deep water removal can be realized stepwisely. What is more important, water removal from oil can be done in less than 3 minutes now by this design, which usually takes 10 minutes or longer. The speed is fast and efficiency is high. Less devices are used and the system supporting cost is lowered.
(4) Three technologies, i.e., degasification, salt removal by injected water and enhanced oil-water separation, are combined together to provide a much better effect. Swirling flow in degassing process realizes degasification and salt exclusion and also rough oil-water separation. The second water injection process improves salt removal and also improves oil-water separation due to water absorption by large-sized water droplets. The different flow rate and route of the oil and the water also promotes salt exclusion and separation to some extent. Thus, this invention makes a coupled design of the above three technologies to enable the functions and also enhance the property.
(5) For oil having a relatively low content of salts, the port for water injection can be closed. The water flows from the left side of partition to the water bag using the connecting vents at left and right sides of partition. The presence of the partition helps to preliminarily separate oil and water into different layers so that the fluctuation of the water content in oil will not lead to the increase of oil content at the oil outlet. The device of this invention is small in land occupation and has a high rate and efficiency in oil-water separation. It enhances the degassing and water removal properties of the conventional technology and adds desalting function at the same time. It can be widely used in low-pressure separation process in petroleum refining and also the separation process involving reflux tank at the tower top.

### BRIEF DESCRIPTION OF DRAWINGS

FIG. 1 is a drawing showing the device of Example 1 for enhancing oil-water separation and desalination in a low-pressure separator.

### DESCRIPTION OF NUMERAL SYMBOLS

1: Oil-water-gas inlet;
2-1 & 2-2: water injection port;
3: T-shaped liquid-gas separator;
4: Flow conditioner,
5: Oil-water agglomeration module;
6: CPI fast separation module;
7: Deep oil removal module;
8: Gas outlet;
9: Deep water removal module;
10: Liquid level controller,
11-1, 11-2 & 11-3: Regulating value;
12: Mixed water outlet;
13-1 & 13-2: Interface level controller;
14: Coupling valve;
15: Water returning port;
16: Water outlet 1;
17: Water outlet 2;
18: Partition;
19: Oil outlet.

### DETAILED DESCRIPTION OF EMBODIMENTS

The method and the device of this invention will be described below with reference to the Example. The example only makes further explanation of this invention and does not limit the protective scope of this invention.

### Example 1

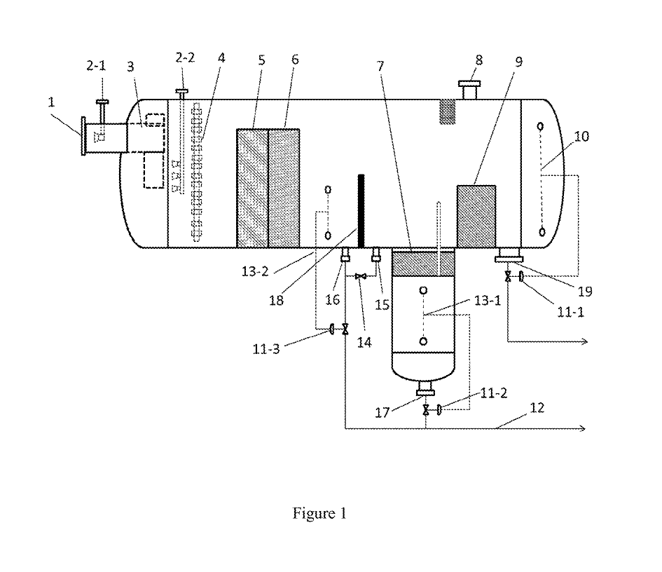

As shown in FIG. 1, a device for enhancing oil-water separation and desalination in a low-pressure separator contained a casing, an oil-water-gas inlet 1 set on the casing, an water injection port 2-1 and a T-shaped liquid-gas separator 3 (or a rotational flow degasser) that separately connected with the oil-water-gas inlet 1; a second injector (comprising a water injection port 2-2), a flow conditioner 4, an oil-water agglomeration module 5, a CPI fast separation module 6, an (oil-water) interface level controller 13-1, an (oil-water) interface level controller 13-2, a partition 18, a liquid level controller 10 and an oil outlet 19, which were disposed within the casing in said order with the oil outlet set on the posterior end of the casing; a deep oil removal module 7 set on the bottom of the casing and a gas outlet 8 in the top of the casing; and a water outlet 17 set on the bottom of the casing. Regulating valves 11-1, 11-2 and 11-3 are provided on the oil outlet 10, the water outlet 17 and the water outlet 16, respectively.

The casing can be horizontal or vertical. The horizontal type was adopted in Example 1.

A part of gas was evaporated due to the reduced pressure after oil entered via the oil-water-gas inlet 1. The oil-water-gas contacted with desalted water having a droplet size of 10 to 50 μm injected from water injection port 2-1 in counter current to perform initial salt removal. Fast separation of liquid from gas was done in the T-shaped liquid-gas separator. Because the T-shaped liquid-gas separator made fast separation of liquid from gas through centrifugal force realized by the tangential inlet, water droplets injected from water injection port moved outward gradually on the transverse section of the T-shaped separator and moved downward on the longitudinal section under the centrifugal force to complete secondary salt removal in addition to gas-liquid separation. The oil-water mixture entered into the low pressure separator from lower outlet of the T-shaped separator.

The oil-water mixture flowed from left to right and mixed with and washed by the 30 to 50 μm sized desalted water injected from water injection port 2-2. Deep salt removal was done during this period. Then, the resultant flow entered the flow conditioner 4 for conditioning so that the oil-water mixture would be uniformly distributed on the transverse section of the vessel. The flow rate of the oil-water mixture was 0.005 to 0.05 m/s after flow conditioning. The oil-water mixture entered the oil-water agglomeration module 5 for differential flowing among baffle plates of the agglomeration module. Due to hydrophilia of the surface of agglomeration baffle plate, large water droplets in oil-water mixture formed a water film rapidly on the surface of plate which further absorbed small water droplets in the oil to realize water droplet coalescence. After this process, the oil-water mixture entered the CPI fast separation module 6 and performed an initial water removal process rapidly based on water settlement in shallow pools of multiple corrugated plates. Water droplets with particle size larger than 30 μm were separated efficiently in this process. An oil-water interface was formed at the left side of the partition 18. The regulating valve 11-3 was opened by the interface level controller 13-2 and the water passed the water outlet 16 and the mixed water outlet 12 to complete water excretion while oil passed through the partition 18 for the deep water removal process.

The water entering the deep water removal zone generally had a droplet size less than 30 μm. A section for natural settlement was set on the right side of partition at first to make settling separation of some small water droplets that can be settled to tank bottom and then to the water bag. In addition, even if the foregoing oil-water separation process or the amount of water contained in oil at entrance fluctuated, adjustment can be made at this section. Thereafter, the oil-water mixture containing tiny water drops entered deep water removal module 9 where the amount of hydrophilic fibers was 5 to 15% of that of the oleophilic fibers. In the meantime of maintaining low pressure settlement (it was easy for oil to penetrate fibrous layer through oleophilic fibers), deep separation of water droplets were realized (a part of emulsified water droplets carried tiny water droplets which would be captured and separated by the hydrophilic fibers). The captured water drops coalesced at the hydrophilic fibers and then entered the water bag. The water drops were subject to the deep oil removal in the deep oil removal module 7 formed by conjugated fibers and then settled down in the water bag to form an oil-water interface. The regulating valve 11-2 was opened by the interface controller 13-1 and the water entered the mixed water outlet 12 from the water outlet 17 to complete water excretion. The oil excretion was completed at the oil outlet 19 through the regulating valve 11-1 controlled by the liquid-level controller 10.

Furthermore, if salt content in oil was relatively low and thus it was not necessary to make water injection and salt exclusion or alternatively less than 0.5% of injected water by volume was used, the coupling valve 14 shall be opened and water would enter the water bag to complete water excretion.

Table 1 showed the characteristic and operating parameters of a cold low pressure separator in a hydrogenation unit in an oil refinery.

TABLE 1

| Item | Technological operation data | |
|---|---|---|
| Feedstock | Oil-gas, oil, H₂S, | |
| | hydrogen gas, water | |
| Total flow rate | 37000 | kg/h |
| Gas | 2703 | kg/h |
| Oil | 34184 | kg/h |
| Water | 113 | kg/h |
| Temperature | 50° | C. |
| Operating pressure | 3.0 | MPa |
| Gas density | 22.835 | kg/m³ |
| Oil density | 685.992 | kg/m³ |
| Chloridion content | 80 | μg/g |
| H₂S content in liquid | 0.6253% | (W) |
| Hydrogen concentration in liquid | 0.0236% | (W) |

According to the above operating parameters, a gravity settling tank whose diameter was 2000 mm and tangent length was 5800 mm was designed in the cold low pressure separator to make oil-water-gas three-phase separation. After half a year, it was found that water content in oil outlet exceeded 2000 ppm frequently, oil content of water in water outlet exceeded 1000 ppm, and severe corrosion occurred at the stripping tower and fractionating tower at the downstream of the cold low-pressure separator, which brought about problems in use of the device in the long run. Thus, the technology of the instant invention was adopted to modify this process.

General requirements of modification were as follows. The water content of oil at exit should be less than 300 ppm, oil content in water should be less than 200 ppm, and salt deposition and corrosion of stripping tower and fractionating tower should be avoided so as to guarantee long-term operation.

Specific Modification:

(1) Process parameters: the diameter of device was 1600 mm and tangent length was 3600 mm, which was calculated according to liquid flow rate of 0.02 m/s, average liquid height of 50% and residence time of 180 s; Due to tiny salt content and the resulting corrosion found after half a year of operation, only one time of water injection was designed and the volume of the injected water was 0.5% of that of the oil.
(2) Internal configurations: The T-shaped liquid-gas separator was disposed at the entrance and the flow rate at entrance was controlled at 4.8 m/s to perform both the fluid degassing and the oil-water mixing and separation; baffle plate made of 316L stainless steel was used in the droplet agglomeration module 5 to obtain water drops of large sizes. The CPI module was made of modified PP corrugated plate. Distance between each two adjacent plates was controlled to 10 mm and percentage of opening at recession was 3% to perform fast settlement after coalescence of water drops; The deep water removal module 7 was made of nylon, Teflon, and a module weaved by both 316L stainless steel and fiber, the ratio of which three was 2:7:1 by mass; The deep oil removal module 7 was made of glass fiber, Teflon fiber and a module weaved by both 316L stainless steel and fiber, the ratio of which three was 6:3:1 by mass.
(3) Control of water discharging: water injection volume was 0.5% which was relatively big and went beyond the processing capacity of water outlet 17. Thus, water outlet 16 and water outlet 17 were controlled by the interface gauge and used together for water discharge; Oil discharge was controlled by the liquid-level controller and performed when the height of liquid level was over 60%.

Implementation effect indicated that after the method in this invention was adopted for modification, hydrogen content in oil was lowered to 22%, oil content in water at the outlet became 80 to 180 ppm, water content in oil at exit became 210 to 290 ppm, and chloridion content was lowered to 11 μg/g in the cold low-pressure separator. In contrast to the previous gravity settling separation technology, the present process had the following beneficial effects.

(1) Hydrogen content in oil was lowered but hydrogen recovery was improved. Gas load at the top of downstream fractionating tower was lowered and the economic benefit was improved.
(2) Oil content in water and water content in oil at the outlets met design requirements and eliminated the problems brought to downstream devices.
(3) Chloridion content at the oil outlet and corrosion rate of downstream stripping tower and fractionating tower were lowered and continuous running period of device was improved.
(4) Less land occupation of device had a certain economic benefit.

What mentioned above is a preferable example of this invention and will not limit the scope of this invention. In other words, any equivalent change and modification made on basis of the scope of this invention falls within scope of this invention.

What is claimed is:

1. A method for enhanced oil-water separation and desalination in a cold low-pressure separator, comprising the steps of
1) mixing water-containing oil with desalted water at entrance to transfer salts and hydrogen sulfide in the oil to the desalted water, and flowing the resultant oil-water mixture into a T-shaped liquid-gas separator to rapidly separate gas from the oil-water mixture via flash evaporation, wherein the oil has a pressure of 0.6-4.5 MPa and a temperature of 20-90° C. at the entrance, and the desalted water is injected in such a rate that the injected desalted water accounts for 0-1% of the water-containing oil by volume;
2) subjecting the oil-water mixture to secondary washing by injected water, flow conditioning and preliminary separation to separate water having a droplet size over 30 μm, wherein a hydrophilic droplet agglomeration module and a CPI fast separation module are used in the preliminary separation, the hydrophilic droplet agglomeration module is adopted to rapidly agglomerate the water droplets scattering in oil, and the CPI fast separation module performs rapid oil-water separation, the separated water is automatically discharged from bottom by an oil-water interface level controller, or alternatively enters a deep separation chamber through ports at both sides of a partition while oil with a trace of water flows through the partition for next processing step, wherein the water injected in the secondary washing accounts for 0-0.5% of the oil-water mixture, the conditioned oil-water mixture flows in a flow velocity of 0.005-0.05 m/s, and space between each two adjacent corrugated plates in the CPI module is 5-18 mm; and
3) subjecting the oil with a trace of water to gravity settling followed by a conjugated fiber water removal module containing hydrophilic fibers and oleophilic fibers to separate water droplets having a size of 3-30 μm, automatically discharging the resultant oil by a liquid level controller while at the same time subjecting the separated water to a conjugated fiber oil removal module containing hydrophilic fibers and oleophilic fibers to obtain water containing less than 100 mg/L of oil and then automatically discharging the resultant water by an oil-water interface level controller, wherein water droplets with larger size are settled down during the gravity settling to bottom and then into a water bag;
wherein the amount of the hydrophilic fibers is 5 to 15% of that of the oleophilic fibers in the conjugated fiber water removal module; the amount of the oleophilic fibers is 10 to 20% of that of the hydrophilic fibers in the conjugated fiber oil removal module.

2. The method of claim 1, wherein the desalted water is injected in step 1) in a direction that is the same with or opposite to the oil's flowing direction, and the injected water is dispersed in the oil with a droplet size of 10 to 50 μm.

3. The method of claim 1, wherein the oil-water mixture flows in a velocity of 3 to 6 m/s at entrance of the T-shaped liquid-gas separator in step 1).

4. The method of claim 1, wherein, the water is injected in the secondary washing of step 2) in a direction opposite to the oil's flowing direction by a jet and a pipe, and the injected water is dispersed in oil with a droplet size of 30 to 100 μm.

5. The method of claim 1, wherein the hydrophilic droplet agglomeration module and the CPI fast separation module in step 2) are made of modified Teflon, polypropylene or stainless steel material.

6. A device for enhanced oil-water separation and desalination for carrying out the method of claims 1 to 5, comprising a casing, an oil-water-gas inlet disposed on the casing, an injector and a T-shaped liquid-gas separator or a rotational flow degasser separately connected with the oil-water-gas inlet; a second injector, a flow conditioner, an oil-water agglomeration module, a CPI fast separation module, an oil-water interface level controller, a partition, a liquid level controller, and an oil outlet, which are disposed within the casing in said order, with the oil outlet disposed at posterior end of the casing; a liquid eliminator disposed on bottom of the casing, a gas outlet on top of the casing, and a water outlet set on the bottom of the casing.

7. The device of claim 6, wherein, the oil outlet, the gas outlet and the water outlet are provided with a regulating valve, respectively.

8. The device of claim 6, wherein, an oil-water interface level controller is disposed inside the liquid eliminator.

9. The device of claim 6, wherein, the casing is a horizontal typed or a vertical typed casing.
